(19) United States
(12) Patent Application Publication
(10) Pub. No.: US 2013/0169854 A1
(43) Pub. Date: Jul. 4, 2013

(54) CAMERA MODULE, ELECTRONIC DEVICE COMPRISING THE SAME AND AUTO FOCUS METHOD

(71) Applicants: Chongzhao GE, Beijing (CN); Zhiyuan CUI, Beijing (CN); Qingfa YANG, Beijing (CN)

(72) Inventors: Chongzhao GE, Beijing (CN); Zhiyuan CUI, Beijing (CN); Qingfa YANG, Beijing (CN)

(73) Assignee: SONY ERICSSON MOBILE COMMUNICATIONS AB, Lund (SE)

(21) Appl. No.: 13/586,040

(22) Filed: Aug. 15, 2012

(30) Foreign Application Priority Data
Dec. 31, 2011 (CN) 201110459902.8

(51) Int. Cl. H04N 5/232

(52) U.S. Cl. 348/345; 348/E05.045

(57) ABSTRACT

A camera module, an electronic device comprising the same and an Auto Focus (AF) method, wherein the camera module controls an AF according to received direction information of the camera module. The camera module includes: a memory configured to store focus drive information of the camera module in different directions; a lens drive unit configured to call the focus drive information stored in the memory and corresponding to the direction information according to the direction of the camera module sensed by the sensor, and drive a lens group according to the focus drive information to perform the AF; and the lens group configured to perform the AF according to the driving by the lens drive unit. The start and stop positions or the preset position of the AF may be more accurately recorded, thereby reducing the power consumption while reducing the time to respond (response time).

### FIELD OF THE INVENTION

The present invention relates to the electronic field, and particularly, to a camera module, an electronic device comprising the same and an auto focus method.

### DESCRIPTION OF THE RELATED ART

As electronic technologies and communication technologies rapidly develop, some electronic devices, such as mobile terminals, has become an indispensable part of people's daily lives. They integrate many functions and bring great conveniences to people's lives and works. In these electronic devices, the camera module for taking photos or shooting videos is an indispensable part.

Currently, there is a camera module that uses the Voice Coil Motor (VCM) as the lens drive unit to drive the lens group (hereinafter referred to as lens) so as to perform an Auto Focus (AF). With respect to the camera module that uses the VCM to perform an AF, the Depth of Focus (DOF) usually ranges from infinity to 10 cm. Different DOFs correspond to different lens positions, and each position of the lens has corresponding drive current value. Most manufacturers write the drive current values corresponding to the infinite position and the 10 cm position into a memory (a memory of the camera module, or a memory of the electronic device comprising the camera module), so as to reduce the response time and the power consumption.

### SUMMARY OF THE INVENTION

The inventor finds that the method that just writes the minimum and maximum drive current values into the memory cannot accurately judge the start or stop position of the AF.

The present invention is proposed with respect to the above problem of the prior art.

The present invention is dedicated to providing a camera module, an electronic device comprising the same and an auto focus method, so as to control the AF of the camera module more accurately.

According to a first aspect of the embodiment of the present invention, a camera module is provided, wherein the camera module controls an AF according to received direction information of the camera module, comprising:

a memory configured to store focus drive information of the camera module in different directions;

a lens drive unit configured to receive the direction information of the camera module transmitted by a sensor, call the focus drive information stored in the memory and corresponding to the direction information according to the direction information, and drive a lens group according to the focus drive information to perform the AF; and

the lens group configured to perform the AF according to the driving by the lens drive unit.

According to a second aspect of the embodiment of the present invention, a camera module of the first aspect is provided, wherein the focus drive information comprises:

start current and stop current; and/or

preset current; and/or

peak voltage; and/or

voltage rise time; and/or

preset voltage; and/or

preset voltage rise time.

According to a third aspect of the embodiment of the present invention, a camera module of the first aspect is provided, wherein the focus drive information comprises:

code values corresponding to start current and stop current; and/or

a code value corresponding to preset current; and/or

a code value corresponding to peak voltage; and/or

a code value corresponding to voltage rise time; and/or

a code value corresponding to preset voltage; and/or

a code value corresponding to preset voltage rise time.

According to a fourth aspect of the embodiment of the present invention, a camera module of the first aspect is provided, wherein the lens drive unit comprises:

a receiving unit configured to receive the direction information of the camera module transmitted by the sensor;

a determining unit configured to determine a direction of the camera module according to the direction information of the camera module transmitted by the sensor and received by the receiving unit;

a calling unit configured to call the focus drive information stored in the memory and corresponding to the direction of the camera module, according to the direction of the camera module determined by the determining unit; and

a driving unit configured to drive the lens group according to the focus drive information called by the calling unit to perform the AF.

According to a fifth aspect of the embodiment of the present invention, a camera module of the first aspect is provided, wherein the lens drive unit is a Voice Coil Motor (VCM) or a piezoelectric ceramic (Piezo).

According to a sixth aspect of the embodiment of the present invention, a camera module of the first aspect is provided, wherein the camera module further comprises the sensor.

According to a seventh aspect of the embodiment of the present invention, an electronic device comprising a sensor and a camera module is provided, wherein the camera module controls an Auto Focus (AF) according to direction information of the camera module transmitted by the sensor, the camera module comprising:

a memory configured to store focus drive information of the camera module in different directions;

a lens drive unit configured to receive the direction information of the camera module transmitted by the sensor, call the focus drive information stored in the memory and corresponding to the direction information according to the direction information, and drive a lens group according to the focus drive information to perform the AF; and

the lens group configured to perform the AF according to the driving by the lens drive unit.

According to an eighth aspect of the embodiment of the present invention, an Auto Focus (AF) method adapted to an electronic device having a camera module is provided, the method comprising:

receiving, by a lens drive unit of the camera module, direction information of the camera module transmitted by a sensor;

calling, by the lens drive unit of the camera module, focus drive information stored in the memory and corresponding to the direction information, according to the direction information of the camera module; and

driving, by the lens drive unit of the camera module, a lens group of the camera module according to the focus drive information to perform the AF.

The embodiments of the present invention have the following beneficial effect: with the embodiments of the present invention, the start and stop positions of the AF may be more accurately recorded, thereby reducing the power consumption while increasing the response time (reference to “increasing” response time herein means reducing the amount of time that it takes to respond).

These and further aspects and features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

Many aspects of the invention can be better understood with reference to the following drawings. The components in the drawings are not necessarily to scale, emphasis instead being placed upon clearly illustrating the principles of the present invention. To facilitate illustrating and describing some parts of the invention, corresponding portions of the drawings may be exaggerated in size, e.g., made larger in relation to other parts than in an exemplary device actually made according to the invention. Elements and features depicted in one drawing or embodiment of the invention may be combined with elements and features depicted in one or more additional drawings or embodiments. Moreover, in the drawings, like reference numerals designate corresponding parts throughout the several views and may be used to designate like or similar parts in more than one embodiment.

### BRIEF DESCRIPTION OF THE DRAWINGS

The included drawings provide further understandings of the present invention, and constitute a part of the Specification. The drawings illustrate the preferred embodiments of the present invention and elaborate the principle of the present invention together with the literal descriptions, wherein the same element is always represented with the same reference numeral. In the drawings,

FIG. 1 is a constitutional diagram of a camera module according to an embodiment of the present invention;

FIGS. 2a to 2c are stress state diagrams of a camera module (VCM) in different directions;

FIGS. 3a to 3c are stress state diagrams of a camera module (piezo) in different directions;

FIG. 4 is a relation diagram of peak voltage and voltage rise time in the embodiment as illustrated in FIGS. 3a to 3c;

FIG. 5 is a constitutional diagram of an electronic device according to an embodiment of the present invention; and

FIG. 6 is a flowchart of an auto focus method according to an embodiment of the present invention.

### DETAILED DESCRIPTION OF THE PREFERRED EMBODIMENTS

The interchangeable terms “electronic device” and “electronic apparatus” include portable radio communication device. The term “portable radio communication device” (hereinafter referred to as “mobile radio terminal”, “portable electronic apparatus” or “portable communication apparatus”) includes devices such as mobile phone, pager, communication apparatus, electronic diary, personal digital assistant (PDA), smart phone, portable communication apparatus, etc.

In the present application, the embodiments of the present invention are mainly described with respect to the portable electronic apparatus in a form of mobile phone (also referred to as “cell phone”). However, it shall be appreciated that the present invention is not limited to the mobile phone, and may relate to an electronic device of any appropriate type, e.g., media player, game device, PDA, computer, digital camera, etc.

The preferred embodiments of the present invention are described as follows with reference to the drawings.

### Embodiment 1

The embodiment of the present invention provides a camera module capable of controlling the AF according to received direction information of the camera module, so as to reduce the power consumption while increasing the response time, i.e., reducing the amount of time that it takes to respond to do the autofocusing function.

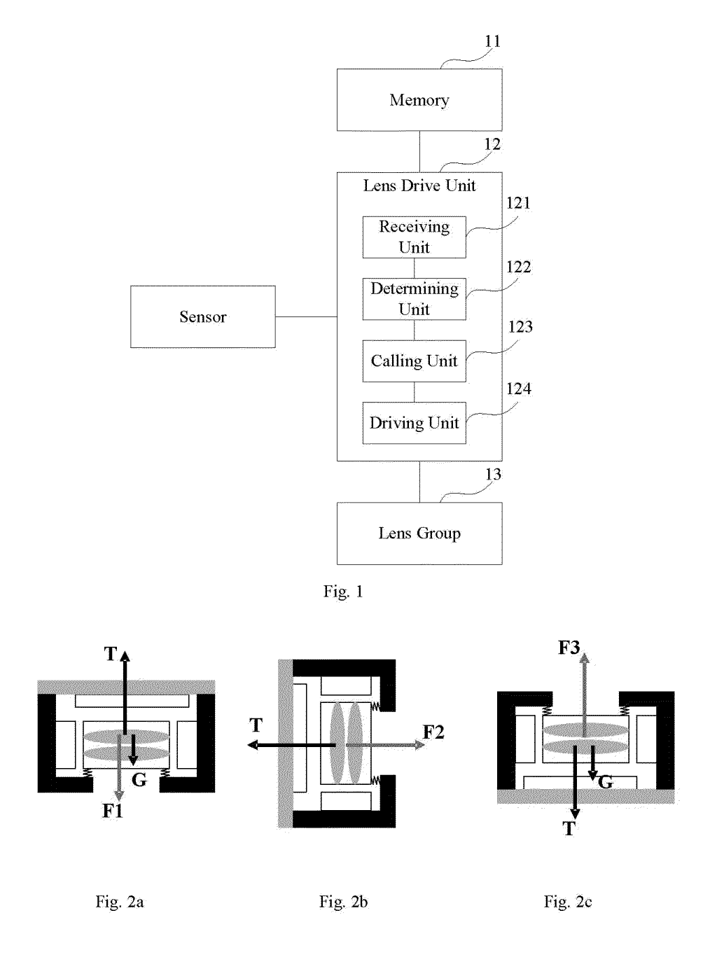

FIG. 1 is a constitutional diagram of a camera module 10 according to an embodiment of the present invention. As illustrated in FIG. 1, the camera module includes:

a memory 11 configured to store focus drive information of the camera module in different directions;

a lens drive unit 12 configured to receive direction information of the camera module transmitted by a sensor 14, call the focus drive information stored in the memory 11 and corresponding to the direction information according to the direction information, and drive a lens group according to the focus drive information to perform an AF; and

a lens group 13 configured to perform the AF according to the driving by the lens drive unit 12.

In one embodiment, the lens drive unit 12 is a VCM, and the focus drive information is start current and stop current, or preset current, or start current, stop current and preset current. FIGS. 2a to 2c are schematic diagrams of a camera module using the VCM as the lens drive unit in different directions.

Referring to FIGS. 2a to 2c, although the lens 15 is disposed at the same position in the camera module, as shown in these figures, due to the gravity of the lens, the drive current value varies when the camera module is in different directions. In case the camera module faces downwards (FIG. 2a), a force F1 driving the lens to move is a difference between a spring resistance T of a spring supporting the lens and a gravity G of the lens itself. In case the camera module faces rightwards (FIG. 2b), a force F2 driving the lens to move is equal to the spring resistance T. In case the camera module faces upwards (FIG. 2c), a force F3 driving the lens to move is a sum of the spring resistance T and the gravity G of the lens itself. It can be seen that when the camera module is in different directions, the required drive current value varies as the force driving the lens to move is different, and the smaller the force driving the lens to move is, the smaller the required drive current value is. Thus, when the lens is at a position where the DOF is infinite, generally, the manufacturer just writes the minimum drive current value in the three directions into the memory as the start current, so that the drive current value can apply to the other two directions. When the lens is at a position where the DOF is 10 cm, it is a similar situation, and the manufacturer only writes the maximum drive current value in the three directions into the memory as the stop current, so as to apply to all the situations. However, the direction of the camera module is not considered, thus the method cannot accurately judge the start or stop position of the AF.

In the embodiment, the focus drive information of the camera module in different directions, such as the start current and the stop current, are written into the memory 11 in advance. For example, before leaving the factory, the camera module may be put in different directions to measure the drive currents of the focus at the infinity and 10 cm in each direction, and the current values are written into the memory as the start current and the stop current in each direction. The above description is just an example, and the embodiment is not limited thereto. For example, the start current and the stop current of the camera module in each direction may be remotely downloaded into the memory of the camera module during an initialization after the camera module leaves the factory.

In another embodiment, the preset current of the camera module in each direction may be written into the memory 11 in advance. The preset current refers to the drive current required by the lens group at a predetermined position. As described above, since the camera module bears different forces in different directions, the required drive current also varies, and the same equally applies to a specific position. The operator may focus to a certain position at one step through the preset current. For example, the operator starts the function through a certain functional module, and a sensor senses the direction of the camera module and transmits direction information to the camera module, which calls a preset current corresponding to the direction information according to the direction information and drives the lens group according to the preset current to perform an AF, thereby directly focusing to the position desired by the operator. Similarly, the preset current may be written into the memory before the camera module leaves the factory, or remotely downloaded into the memory during an initialization after the camera module leaves the factory, and the embodiment is not limited thereto.

In the above embodiment, examples are given by taking the start current and the stop current or the preset current as the focus drive information, but the embodiment is not limited thereto. In the implementation, the start current and the stop current or the preset current may not be stored, instead, the voltage values or code values corresponding thereto may be stored. Any implementation is within the protection scope of the present invention as long as it is possible to drive the lens group to perform an AF according to the focus drive information.

In the embodiment, the camera module may face rightwards, downwards and leftwards. As illustrated in FIGS. 2a-2c, the memory 11 stores the focus drive information (start current and stop current and/or preset current, etc.) of the camera module in the three directions, but the embodiment is not limited thereto. During the implementation, the focus drive information in more directions may be stored according to the accuracy requirement. The method for writing the focus drive information into the memory has been described before, and herein is omitted.

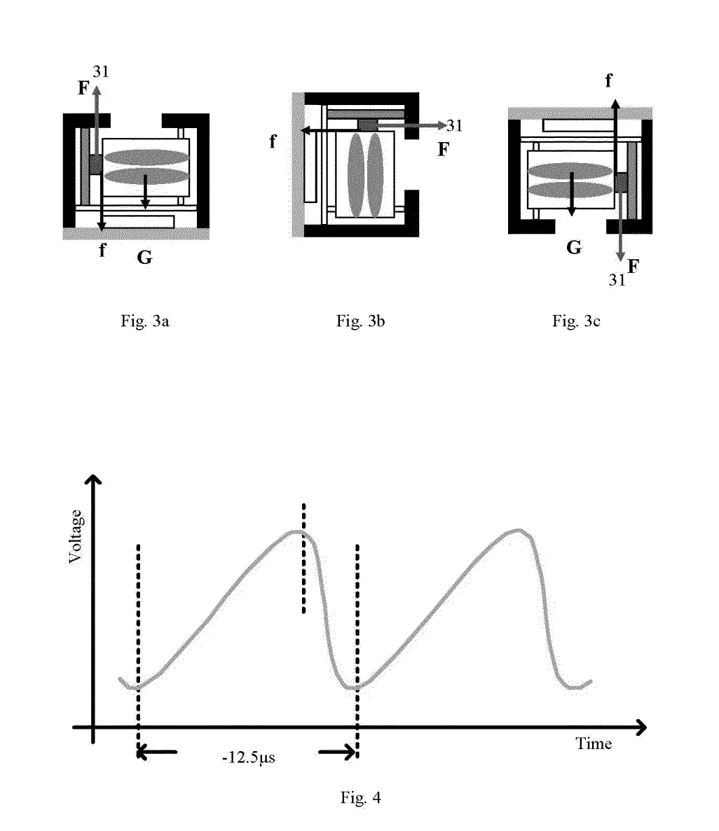

In another embodiment, the lens drive unit 12 is piezoelectric ceramic (piezo), and the focus drive information is the peak voltage or the voltage rise time. FIGS. 3a to 3c are schematic diagrams of a camera module using piezo as the lens drive unit in different directions.

Referring to FIGS. 3a to 3c, the piezo has a characteristic that a deformation may appear after a voltage is applied and within the deformation range, the higher the voltage is the larger the deformation is. Therefore, when a slow voltage rise signal is applied to a piezo module 31, the piezo is deformed and drives the lens group to move together; in that case, the piezo and the lens group are relatively static to each other, and the movement is made by overcoming the static friction; next, a quick voltage drop signal is applied to the piezo module so that it quickly returns to the original position, while the lens group stops at the position where it moves to, thereby completing a movement cycle. When the piezo is used as the lens drive unit to drive the lens group to perform an AF, for example a saw-tooth voltage pulse signal as shown in FIG. 4 is applied to the piezo module so that the lens group moves and focuses. When the lenses are in different directions, the moving force F shall overcome not only the static friction f but also the gravity G. Thus when different directions are sensed, the movement accuracy may be controlled by controlling the peak voltage or the voltage rise time (i.e., the voltage rise speed) of the saw-tooth pulse.

In the embodiment, peak voltages or voltage rise time used in different directions (positions) are written into the memory in advance, and serving as the lens drive unit, the piezo calls the peak voltage or voltage rise time according to received direction information of the camera module, thereby driving the lens group according to the peak voltage or voltage rise time to perform an AF.

Similarly, in order to focus to a certain position at one step, preset voltages or preset voltage rise time corresponding to different directions may also be stored in the embodiment where the piezo is taken as the lens drive unit. The working process is similar to the previous one, and herein is omitted.

In the embodiment, the camera module 10 may face rightwards, downwards and leftwards. As illustrated in FIGS. 3a-3c, the memory 11 stores the focus drive information (peak voltage, voltage rise time, preset voltage, preset voltage rise time, etc.) of the camera module in the three directions, but the embodiment is not limited thereto. In the implementation, the focus drive information in more directions may be stored according to the accuracy requirement. The method for writing the focus drive information into the memory has been described before, and herein is omitted.

In one embodiment, the lens drive unit 12 includes:

a receiving unit 121 configured to receive direction information of the camera module transmitted by the sensor 14;

a determining unit 122 configured to determine the direction of the camera module according to the direction information of the camera module received by the receiving unit 121;

a calling unit 123 configured to call focus drive information stored in the memory 11 and corresponding to the direction of the camera module according to the direction of the camera module determined by the determining unit 122; and

a driving unit 124 configured to drive the lens group 13 according to the focus drive information called by the calling unit 123 to perform an AF.

In the embodiment, the sensor may be a sensor 14 of the camera module 10, or a sensor of an electronic device including the camera module. By using a sensor of the electronic device that includes the camera module according to the embodiment of the present invention to sense the direction of the camera module, the available resources of the electronic device can be sufficiently utilized to save cost. The sensor 14 may be a gravity sensor or other type of sensor such as acceleration sensor. Any sensor capable of sensing the direction of the camera module 10 shall be covered by the protection scope of the embodiment of the present invention.

In the embodiment, the lens group 13 includes structures such as lens 15, photoreceptor 16 and filter glass (not shown). The structures and functions thereof may employ those of the conventional (prior art) lens group, and herein are omitted. In addition, the camera module 10 further includes a case, a circuit board, etc., and the structures and functions thereof may also employ those of the existing ones, which are omitted herein.

With the camera module according to the embodiment of the present invention, the start and stop positions or the preset position of the AF may be more accurately recorded because the focus drive information of the camera module in each direction is recorded, thereby reducing the power consumption while increasing the response time.

### Embodiment 2

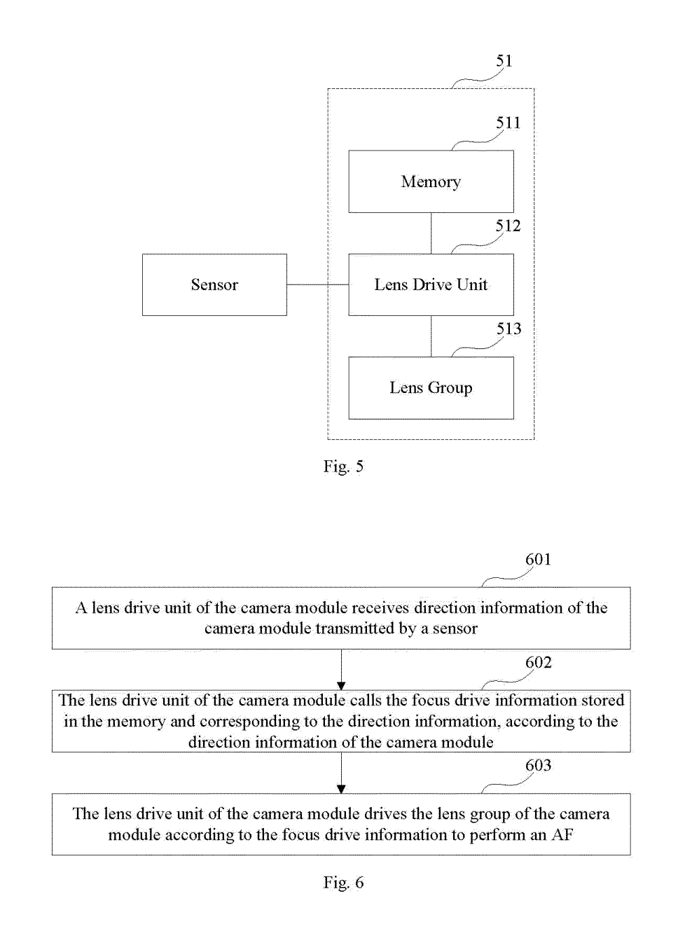

The embodiment of the present invention further provides an electronic device 50. FIG. 5 is a constitutional diagram of the electronic device which includes a sensor 14 and a camera module 51, wherein the camera module controls the AF according to direction information of the camera module transmitted by the sensor.

Referring to FIG. 5, in one embodiment, the camera module 51 includes:

a memory 511 configured to store focus drive information of the camera module 51 in different directions;

a lens drive unit 512 configured to receive direction information of the camera module 51 transmitted by a sensor, call the focus drive information stored in the memory 511 and corresponding to the direction information, and drive a lens group according to the focus drive information to perform an AF; and

a lens group 513 configured to perform the AF according to the driving by the lens drive unit 512.

In the embodiment, the camera module 51 may be implemented by the camera module of Embodiment 1, and the specific constitutions and functions thereof are incorporated herein and not described again.

In the embodiment, the sensor 14 is a sensor of the electronic device, and configured to sense the direction of the camera module and transmit the direction information to the lens drive unit 512 of the camera module. The working process has been described before.

With the electronic device according to the embodiment of the present invention, the start and stop positions or the preset position of the AF may be more accurately recorded because the focus drive information of the camera module in each direction is recorded, thereby reducing the power consumption while increasing the response time.

### Embodiment 3

The embodiment of the present invention further provides an AF method. FIG. 6 is a flowchart of the method adapted to an electronic device having a camera module. Referring to FIG. 6, the method includes:

Step 601: a lens drive unit of the camera module receives direction information of the camera module transmitted by a sensor. For example, after sensing the direction of the camera module, the sensor may transmit it to the lens drive unit of the camera module. Herein the sensor may be a sensor of the camera module, or a sensor of the electronic device.

Step 602: the lens drive unit of the camera module calls the focus drive information stored in the memory and corresponding to the direction information, according to the direction information of the camera module. For example, the lens drive unit of the camera module calls the focus drive information stored in the memory and corresponding to the direction information, according to the direction information of the camera module transmitted by the sensor, so as to drive the lens group according to the focus drive information to perform an AF. For example, the focus drive information includes start current and stop current, preset current, peak voltage, voltage rise time, preset voltage, preset voltage rise time, etc. The focus drive information may also be code values corresponding to the above items.

Step 603: the lens drive unit of the camera module drives the lens group of the camera module according to the focus drive information to perform the AF.

After calling the focus drive information corresponding to the direction of the camera module, the lens drive unit of the camera module may drive the lens group of the camera module according to the focus drive information to perform the AF. For example, the action of the lens group is made according to the driving by the lens drive unit, herein is omitted.

With the method according to the embodiment of the present invention, the start and stop positions or the preset position of the AF may be more accurately recorded because the focus drive information of the camera module in each direction is recorded, thereby reducing the power consumption while increasing the response time.

The preferred embodiments of the present invention are described above with reference to the figures. The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

It should be understood that each of the parts of the present invention may be implemented by hardware, software, firmware, or a combination thereof. In the above embodiments, multiple steps or methods may be realized by software or firmware that is stored in the memory and executed by an appropriate instruction executing system. For example, if it is realized by hardware, it may be realized by any one of the following technologies known in the art or a combination thereof as in another embodiment: a discrete logic circuit having a logic gate circuit for realizing logic functions of data signals, application-specific integrated circuit having an appropriate combined logic gate circuit, a programmable gate array (PGA), and a field programmable gate array (FPGA), etc.

The description or blocks in the flowcharts or of any process or method in other manners may be understood as being indicative of comprising one or more modules, segments or parts for realizing the codes of executable instructions of the steps in specific logic functions or processes, and that the scope of the preferred embodiments of the present invention comprise other implementations, wherein the functions may be executed in manners different from those shown or discussed, including executing the functions according to the related functions in a substantially simultaneous manner or in a reverse order, which should be understood by those skilled in the art to which the present invention pertains.

The logic and/or steps shown in the flowcharts or described in other manners here may be, for example, understood as a sequencing list of executable instructions for realizing logic functions, which may be implemented in any computer readable medium, for use by an instruction executing system, device or apparatus (such as a system including a computer, a system including a processor, or other systems capable of extracting instructions from an instruction executing system, device or apparatus and executing the instructions), or for use in combination with the instruction executing system, device or apparatus. As used herein, “a computer readable medium” can be any device that can contain, store, communicate with, propagate or transmit programs for use by an instruction executing system, device or apparatus, or can be used with the instruction executing system, device or apparatus. A computer readable medium may be, for example, but not limited to, an electronic, magnetic, optical, electromagnetic, infrared or semiconductor system, device, apparatus, or a propagation medium. More particular examples (inexhaustive lists) of a computer readable medium may comprise the following: an electrical connecting portion (electronic device) having one or more wirings, a portable computer hardware box (magnetic device), a random access memory (RAM) (electronic device), a read-only memory (ROM) (electronic device), an erasable programmable read-only memory (EPROM or flash memory) (electronic device), an optical fiber (optical device), and a portable compact disk read-only memory (CDROM) (optical device). Furthermore, a computer readable medium may be paper or other appropriate media on which the programs may be printed, as the programs may be obtained electronically through scanning optically the paper or other appropriate media and then compiling, interpreting, or processing in other appropriate manners, as necessary, and then the programs are stored in the computer memory.

The above literal description and drawings show various features of the present invention. It should be understood that a person of ordinary skill in the art may prepare suitable computer codes to carry out each of the steps and processes described above and illustrated in the drawings. It should also be understood that the above-described terminals, computers, servers, and networks, etc. may be any type, and the computer codes may be prepared according to the disclosure contained herein to carry out the present invention by using the devices.

Particular embodiments of the present invention have been disclosed herein. Those skilled in the art will readily recognize that the present invention is applicable in other environments. In practice, there exist many embodiments and implementations. The appended claims are by no means intended to limit the scope of the present invention to the above particular embodiments. Furthermore, any reference to “a device to . . . ” is an explanation of device plus function for describing elements and claims, and it is not desired that any element using no reference to “a device to . . . ” is understood as an element of device plus function, even if the wording of “device” is included in that claim.

Although a particular preferred embodiment or embodiments have been shown and the present invention has been described, it is obvious that equivalent modifications and variants are conceivable to those skilled in the art in reading and understanding the description and drawings. Especially for various functions executed by the above elements (portions, assemblies, apparatus, and compositions, etc.), except otherwise specified, it is desirable that the terms (including the reference to “device”) describing these elements correspond to any element executing particular functions of these elements (i.e. functional equivalents), even though the element is different from that executing the function of an exemplary embodiment or embodiments illustrated in the present invention with respect to structure. Furthermore, although the a particular feature of the present invention is described with respect to only one or more of the illustrated embodiments, such a feature may be combined with one or more other features of other embodiments as desired and in consideration of advantageous aspects of any given or particular application.

1. A camera module which controls an Auto Focus (AF) according to received direction information of the camera module, comprising:
a memory configured to store focus drive information of the camera module in different directions;
a lens drive unit configured to receive the direction information of the camera module transmitted by a sensor, call the focus drive information stored in the memory and corresponding to the direction information according to the direction information, and drive a lens group according to the focus drive information to perform the AF; and
the lens group configured to perform the AF according to the driving by the lens drive unit.

2. The camera module according to claim 1, wherein the focus drive information comprises at least one of:
start current and stop current;
preset current;
peek voltage;
voltage rise time;
preset voltage; or
preset voltage rise time.

3. The camera module according to claim 1, wherein the focus drive information comprises at least one of:
code values corresponding to start current and stop current;
a code value corresponding to preset current;
a code value corresponding to peek voltage;
a code value corresponding to voltage rise time;
a code value corresponding to preset voltage; or
a code value corresponding to preset voltage rise time.

4. The camera module according to claim 1, wherein the lens drive unit comprises:
a receiving unit configured to receive the direction information of the camera module transmitted by the sensor;
a determining unit configured to determine a direction of the camera module according to the direction information of the camera module transmitted by the sensor and received by the receiving unit;
a calling unit configured to call the focus drive information stored in the memory and corresponding to the direction of the camera module, according to the direction of the camera module determined by the determining unit; and
a driving unit configured to drive the lens group according to the focus drive information called by the calling unit to perform the AF.

5. The camera module according to claim 1, wherein the lens drive unit is a Voice Coil Motor (VCM) or a piezoelectric ceramic (Piezo).

6. The camera module according to claim 1, further comprising the sensor.

7. An electronic device comprising a sensor and a camera module, wherein the camera module controls an Auto Focus (AF) according to direction information of the camera module transmitted by the sensor, the camera module comprising:
a memory configured to store focus drive information of the camera module in different directions;
a lens drive unit configured to receive the direction information of the camera module transmitted by the sensor, call the focus drive information stored in the memory and corresponding to the direction information according to the direction information, and drive a lens group according to the focus drive information to perform the AF; and
the lens group configured to perform the AF according to the driving by the lens drive unit.

8. An Auto Focus (AF) method adapted to an electronic device having a camera module, comprising:
receiving, by a lens drive unit of the camera module, direction information of the camera module transmitted by a sensor;
calling, by the lens drive unit of the camera module, focus drive information stored in the memory and corresponding to the direction information, according to the direction information of the camera module; and
driving, by the lens drive unit of the camera module, a lens group of the camera module according to the focus drive information to perform the AF.
